(19) United States
(12) Patent Application Publication
(10) Pub. No.: US 2026/0261140 A1
(43) Pub. Date: Sep. 3, 2026

(54) TEMPERATURE DEPENDING SAFETY TIMER

(71) Applicant: Philip Morris Products S.A., Neuchatel (CH)

(72) Inventors: Ning PAN, Shenzhen (CN); Hongjie XU, Hong Kong (HK); Xing YANG, Zhuhai (CN)

(73) Assignee: Philip Morris Products S.A., Neuchatel (CH)

(21) Appl. No.: 19/491,225

(22) PCT Filed: Jun. 26, 2023
(86) PCT No.: PCT/CN2023/102440

§ 371 Date: Dec. 8, 2025

(51) Int. Cl. H02J 7/90; A24F 40/50; A24F 40/90

(52) U.S. Cl. CPC H02J 7/977; A24F 40/50; A24F 40/90

(57) ABSTRACT

A method for charging a battery in an aerosol-generating system is provided, the method including: determining a temperature indicative of a temperature of the battery; calculating a maximum charging time tₘₐₓ depending on the determined temperature; and terminating charging, if the maximum charging time tₘₐₓ has elapsed, the maximum charging time tₘₐₓ being adjusted based on a last temperature measurement. A charge controller for an aerosol generating system comprising a battery is also provided. An aerosol-generating device comprising a rechargeable battery is also provided. A charging case for an aerosol generating device is also provided.

The present invention relates to a controller and a method for safely charging a battery in an aerosol-generating system and to an aerosol-generating system implementing said method. The present invention also relates to an aerosol-generating device and a charging case to be used in the aerosol-generating system.

Commonly known aerosol-generating systems are portable and electrically operated and typically include re-chargeable batteries to provide the required electrical power. It is critical to charge a battery in an aerosol-generating system in a safe manner—otherwise, the battery can become unstable which can lead to failure of the aerosol generating device. This is particularly important in aerosol-generating systems since these systems typically generate heat and are used in close proximity to users' bodies.

One commonly used safety feature in controllers that charge batteries is a so-called “safety timer”. This safety feature involves timing how long the battery has been charged for, and terminating charging, if the battery is still being charged after a predetermined maximum charging time. However, the predetermined maximum charging time may not be appropriate depending on the charging conditions. If the predetermined maximum charging time is too short, then charging will stop prematurely before the battery is charged up to the intended state of charge. On the other hand, if the predetermined maximum charging time is too long, then charging may be allowed to continue for longer than is appropriate, even in situations where the intended state of charge has not yet been reached due to a fault. Ideally, charging is terminated before, or shortly after, any faults in charging the battery might occur, while at the same time allowing the battery to reach its intended state of charge.

Thus, it would be desirable to provide a more sophisticated charging safety timer, which allows to further improve safety of the charging process of a battery in an aerosol-generating system.

It would further be desirable to provide a charging method that allows for increased charging safety, in particular under varying charging conditions.

It would further be desirable to improve the safety timer functionality and in particular to avoid unnecessary delay in termination of the charging process in abnormal charging conditions.

According to an embodiment of the invention there is provided a method for charging a battery in an aerosol-generating system. The method comprises determining a temperature indicative of the temperature of the battery, calculating a maximum charging time tₘₐₓ depending on the determined temperature, and terminating charging, if the maximum charging time tₘₐₓ has elapsed.

According to another embodiment of the invention there is provided a charge controller for an aerosol generating system comprising a battery, the charge controller being configured to: determine a temperature indicative of the temperature of the battery; calculate a maximum charging time tₘₐₓ depending on the determined temperature; terminate charging, if the maximum charging time tₘₐₓ has elapsed.

In conventional battery charging methods a fixed safety timer functionality is implemented throughout the full temperature range in which charging of the battery is allowed. Typically charging of the battery is performed at lower charging rates closer to the endpoints of the operational temperature range. Accordingly, the safety timer is conventionally defined according to the slowest applicable charging rates. Such fixed safety timer reliably terminates the charging process in case of abnormal charging conditions. However, there is a significant delay in terminating the charging process when the battery temperature generally would allow for fast charging.

With the method disclosed herein the charging safety timer may be set such that the maximum charging time may be adapted to the current temperature of the battery to be charged. In particular, if the battery to be charged has a temperature that allows for high charging rates, the expected maximum charging time may be considerably reduced. In such situation the safety timer may be reduced accordingly. By adjusting the safety timer in dependence of the battery temperature, delays in terminating the charging process in abnormal charging situations, such as a faulty battery, may be avoided.

The method may further comprise, inhibiting charging of the battery, if the determined temperature is outside of a pre-determined temperature range. The method may comprise allowing charging of the battery only if the temperature of the battery is within the pre-determined temperature range.

The predetermined temperature range may range between-10 degrees Celsius and 60 degrees Celsius. The predetermined temperature range may range between 0 degrees Celsius and 45 degrees Celsius. By inhibiting charging of the battery when the temperature of the battery is outside of the predetermined temperature range, the risk of causing damage to the battery or the aerosol-generating system may be reduced.

In case the determined temperature is within the predetermined temperature range, the maximum charging time may be determined in dependence of the determined temperature.

The maximum charging time may be expressed as a linear function of the determined temperature. For example, the maximum charging time tₘₐₓ may be calculated from the following equation:

$${t}_{max} ( T ) = m \cdot T + c \qquad ( 1 )$$

wherein tₘₐₓ is the maximum charging time, T is the determined temperature and m, c are empirically determined parameters. Parameters m and c may depend on the battery that is to be charged as well as on constructional details of the aerosol generating system at hand.

The maximum charging time tₘₐₓ may also be calculated as a non-linear function of the determined temperature.

The predetermined temperature range may be sub-divided into two or more sub-ranges. The relationship of the maximum charging time tₘₐₓ may and the determined temperature may be different in each sub-range of the predetermined temperature range. With using different equations for the relationship between the maximum charging time tₘₐₓ may and the determined temperature, precision of the calculation of the maximum charging time tₘₐₓ may be enhanced.

As mentioned above the predefined temperature range may range from −10 degrees Celsius to 60 degrees Celsius. This temperature range may be subdivided into two or more sub-ranges. Suitable sub-ranges may range from −10 degrees Celsius to 0 degree Celsius, from 0 degree Celsius to 15 degrees Celsius, from 15 degrees Celsius to 45 degrees Celsius, and from 45 degrees Celsius to 60 degrees Celsius. By subdividing the predefined temperature interval into a plurality of sub-ranges, adaption of the safety timer to the determined temperature can be further enhanced.

The temperature may be measured periodically during the charging process. There may be a temperature measurement interval between each temperature measurement. In this way the charging process may be adjusted to changing temperature conditions of the battery. This may be particularly important, since the determined temperature may change during charging. In particular, the determined temperature may increase during charging. In typical charging situations, users may re-charge their devices with pocket chargers held within backpacks or similar temperature isolated environment. The temperature of the battery may considerably build up during the charging process. In such cases, during the charging process, charging current may be increased as soon as the determined temperature has exceeded a predefined threshold into a temperature range, which allows for faster charging. Thereby the required charging time is reduced and the safety timer duration may be substantially reduced. Thus, a dynamic safety timer may help to adjust to the expected battery's charging time in different temperature conditions.

The temperature measurement interval may range from 1 to 20 minutes. The temperature measurement interval may range from 5 to 15 minutes. The temperature measurement interval may be around 10 minutes. The temperature measurement interval may be kept constant throughout the charging process. In a more advanced control method, the temperature measurement interval may be dynamically changed during the charging process. For example, the temperature measurement interval may be reduced if the determined temperature approaches towards end regions of the predefined temperature range or a predefined temperature sub-range.

The maximum charging time tₘₐₓ may be initially calculated in dependence on the determined temperature at the start of the charging process. As discussed above, the determined temperature may be monitored throughout the charging process. In case the determined temperature changes significantly during the charging process, the maximum charging time tₘₐₓ may be adjusted based on the current temperature measurement.

The method may further comprise comparing the maximum charging time tₘₐₓ with a previously calculated maximum charging time tₘₐₓ during the same charging process. The adjustment of the charging time may be carried out such that only an increase of charging time is allowed. In such embodiments, even if the currently calculated charging time would result in a reduced charging timer safety cut-off, the safety timer cut-off is kept constant. This modification in particular may help to avoid premature termination towards the end of the charging process in constant voltage regulation stage of a Li-ion battery. In such stages, the charging current is continuously dropping and the determined temperature may start falling into a temperature sub-range requiring a shorter safety timer. Applying the shorter safety timer may lead to abortion of the charging process even charging is not yet completed. To avoid such premature termination of the charging process, the method may prevent reducing the maximum charging time tₘₐₓ during the charging process. In order to enable this functionality, the method may include a comparison step in which the controller may compare the previously calculated maximum charging time tₘₐₓ with the currently calculated charging time tₘₐₓ.

The temperature indicative of the temperature of the battery may be determined via a thermistor or a thermocouple connected to the controller of the aerosol-generating system.

The battery of the aerosol-generating system may be a Lithium-ion battery. The battery may be a Lithium based battery, for example a Lithium-Cobalt-Oxide, a Lithium-Iron-Phosphate, a Lithium-Nickel-Manganese-Cobalt-Oxide, a Lithium-Nickel-Cobalt-Aluminium-Oxide, a Lithium Titanate or a Lithium-Polymer battery. Such batteries allow to store sufficient energy for mobile aerosol-generating systems. They further allow for rapid and multiple re-charge, which further enhances the user experience.

According to an embodiment of the invention there is provided an aerosol-generating system comprising a battery and a charge controller. The aerosol-generating system is configured to carry out the charging method as described above. For this purpose, the charge controller is configured to determine a temperature indicative of the temperature of the battery, to calculate a maximum charging time Tₘₐₓ depending on the determined temperature, and to terminate charging, if the maximum charging time Tₘₐₓ has elapsed.

The aerosol-generating system may comprise an aerosol-generating device that interacts with an aerosol-forming substrate to generate an aerosol. The aerosol-generating system may further comprise a charging case. The charging case may be a portable charging case. The charging case may be configured to be connected to the aerosol-generating device for charging purposes.

As used herein, an “aerosol-generating system” may comprise an aerosol-generating device and an aerosol-generating article.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomiser, such as an electric heater, to heat the aerosol-forming substrate to form an aerosol.

An aerosol-generating device may be a smoking device that interacts with an aerosol-forming substrate of an aerosol-generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and a heating element.

As used herein with reference to the present invention, the term “smoking” with reference to a device, article, system, substrate, or otherwise does not refer to conventional smoking in which an aerosol-forming substrate is fully or at least partially combusted. The aerosol-generating device of the present invention is arranged to heat the aerosol-forming substrate to a temperature below a combustion temperature of the aerosol-forming substrate, but at or above a temperature at which one or more volatile compounds of the aerosol-forming substrate are released to form an inhalable aerosol.

According to an embodiment of the invention there is provided an aerosol-generating device for use in an aerosol-generating system. The aerosol-generating device comprises a re-chargeable battery, a first power interface for connecting the re-chargeable battery to an external power source, and a host controller for controlling power supply from the re-chargeable battery to an electric heater. The aerosol-generating device further comprises the charge controller as described above. The charge controller may be comprised in a host controller of the aerosol-generating device. Alternatively, the charge controller may be comprised in a battery charger IC of the aerosol-generating device.

By providing the charge controller in the aerosol-generating device, versatility of the aerosol-generating device with respect to charging is increased. In these embodiments the charging process may be controlled by the circuitry provided within the aerosol-generating device. In order to carry out the charging process it is sufficient to connect the aerosol-generating device to a suitable external power source.

The external power source may be a mains AC adaptor which receives an AC input from the mains, and outputs a DC voltage suitable for charging the re-chargeable battery. Typically, a DC output of about 5 Volts is provided from the power supply.

The first power interface for connection to the power supply may be any suitable connection means. The connection means may be a USB interface, such as a USB-A, USB-B or USB-C interface.

The aerosol-generating device may comprise a host microcontroller. The host microcontroller may be configured for executing the required functions of the aerosol-generating device, such as the provision of electrical power to the heater from the battery so that aerosol can be generated from an aerosol generating substrate. The host microcontroller may be further configured to comprise the charge controller. Thus, the host microcontroller may also be configured for executing and controlling the charging process of the re-chargeable battery of the aerosol-generating device.

The aerosol-generating device may also comprise a separate battery charger IC. If a battery charger IC is provided, the battery charger IC may be configured for executing and controlling the charging process of the re-chargeable battery of the aerosol-generating device. The re-chargeable battery of the aerosol-generating device provides power to the host microcontroller and to the heater, so that the aerosol-generating device can be used when it is no longer connected to the power supply.

According to an embodiment of the invention there is provided a charging case for an aerosol generating device as described above. The charging case may comprise a re-chargeable battery, a first power interface for connecting the re-chargeable battery of the charging case to an external power supply. The charging case may comprise a second power interface for connecting the re-chargeable battery of the charging case to a re-chargeable battery of the aerosol generating device. The charging case may further comprise a charge controller as described above for charging the re-chargeable battery of the aerosol-generating device.

By providing the charge controller in the charging case, it is not necessary anymore to provide a charge controller in the aerosol-generating device. Thus, less electronic circuitry is required in the aerosol-generating device. This may reduce manufacturing complexity of the aerosol-generating device. At the same time cost efficiency of the manufacturing process of the aerosol-generating device may be increased.

Again, the external power supply may be a mains AC adaptor which receives an AC input from the mains, and outputs a DC voltage. The first power interface for connecting the charging case to the power supply may be any suitable connection means. The connection means may be a USB interface, such as a USB-A, USB-B or USB-C interface.

The second power interface for connecting the re-chargeable battery of the charging case to a re-chargeable battery of the aerosol generating device may also be any suitable connection means, and may again be a USB interface.

According to an embodiment of the invention there is provided a charging case for an aerosol generating device as described above. The charging case may comprise a re-chargeable battery, a first power interface for connecting the re-chargeable battery of the charging case to an external power supply. The charging case may comprise a second power interface for connecting the re-chargeable battery of the charging case to a re-chargeable battery of the aerosol generating device. The charging case may further comprise a host microcontroller comprising the charge controller as described above for charging the re-chargeable battery of the charging case. Alternatively, the charging case may comprise a battery charger IC comprising the charge controller as described above for charging the re-chargeable battery of the charging case.

The host microcontroller of the charging case may be configured for executing the required functions of the charging case. Such functions may include the downloading of data from the aerosol-generating device. The host microcontroller may also be configured for communicating with an external device, such as a computer. The host microcontroller may be configured for executing the transmission of data downloaded from the aerosol-generating device to an external device, such as a computer, via the USB interface.

As described, in any of the aspects of the disclosure, the heating element may be part of an aerosol-generating device. The aerosol-generating device may comprise an internal heating element or an external heating element, or both internal and external heating elements, where “internal” and “external” refer to the aerosol-forming substrate. An internal heating element may take any suitable form. For example, an internal heating element may take the form of a heating blade. Alternatively, the internal heater may take the form of a casing or substrate having different electro-conductive portions, or an electrically resistive metallic tube. Alternatively, the internal heating element may be one or more heating needles or rods that run through the center of the aerosol-forming substrate. Other alternatives include a heating wire or filament, for example a Ni—Cr (Nickel-Chromium), platinum, tungsten or alloy wire or a heating plate.

An external heating element may take any suitable form. For example, an external heating element may take the form of one or more flexible heating foils on a dielectric substrate, such as polyimide. Alternatively, an external heating element may take the form of a metallic grid or grids, a flexible printed circuit board, a molded interconnect device (MID), ceramic heater, flexible carbon fibre heater or may be formed using a coating technique, such as plasma vapour deposition, on a suitable shaped substrate. An external heating element may also be formed using a metal having a defined relationship between temperature and resistivity. In such an exemplary device, the metal may be formed as a track between two layers of suitable insulating materials. An external heating element formed in this manner may be used to both heat and monitor the temperature of the external heating element during operation.

As an alternative to an electrically resistive heating element, the heating element may be configured as an induction heating element. The induction heating element may comprise an induction coil and a susceptor.

As used herein, the term “aerosol-forming substrate” relates to a substrate capable of releasing one or more volatile compounds that can form an aerosol. Such volatile compounds may be released by heating the aerosol-forming substrate. An aerosol-forming substrate may conveniently be part of an aerosol-generating article.

The aerosol-forming substrate may be a solid aerosol-forming substrate. The aerosol-forming substrate may comprise both solid and liquid components. The aerosol-forming substrate may comprise a tobacco-containing material containing volatile tobacco flavour compounds which are released from the substrate upon heating. The aerosol-forming substrate may comprise a non-tobacco material. The aerosol-forming substrate may comprise an aerosol former that facilitates the formation of a dense and stable aerosol. Examples of suitable aerosol formers are glycerine and propylene glycol.

The aerosol-generating substrate preferably comprises homogenised tobacco material, an aerosol-former and water. Providing homogenised tobacco material may improve aerosol generation, the nicotine content and the flavour profile of the aerosol generated during heating of the aerosol-generating article. Specifically, the process of making homogenised tobacco involves grinding tobacco leaf, which more effectively enables the release of nicotine and flavours upon heating.

As used herein, the term “aerosol-generating article” refers to an article comprising an aerosol-forming substrate that is capable of releasing volatile compounds that can form an aerosol. For example, an aerosol-generating article may be a smoking article that generates an aerosol that is directly inhalable into a user's lungs through the user's mouth. An aerosol-generating article may be disposable.

The aerosol-generating article may be substantially cylindrical in shape. The aerosol-generating article may be substantially elongate. The aerosol-generating article may have a length and a circumference substantially perpendicular to the length. The aerosol-generating article may be substantially rod shaped. The aerosol-forming substrate may be substantially cylindrical in shape. The aerosol-forming substrate may be substantially elongate. The aerosol-forming substrate may also have a length and a circumference substantially perpendicular to the length. The aerosol-forming substrate may be substantially rod shaped.

Features described in relation to one embodiment may equally be applied to other embodiments of the invention. The invention will be further described, by way of example only, with reference to the accompanying drawings in which:

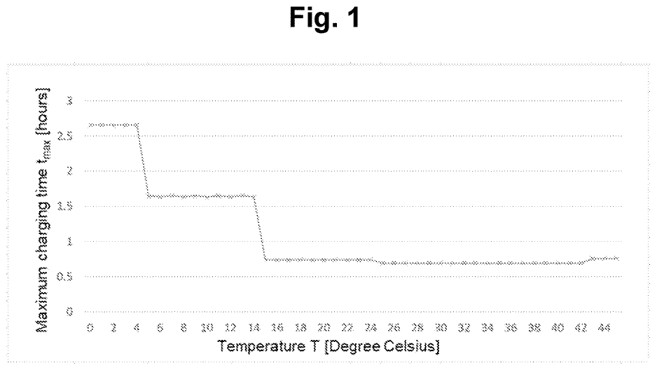

FIG. 1 shows a diagram illustrating the required charging time in dependence of the battery temperature;

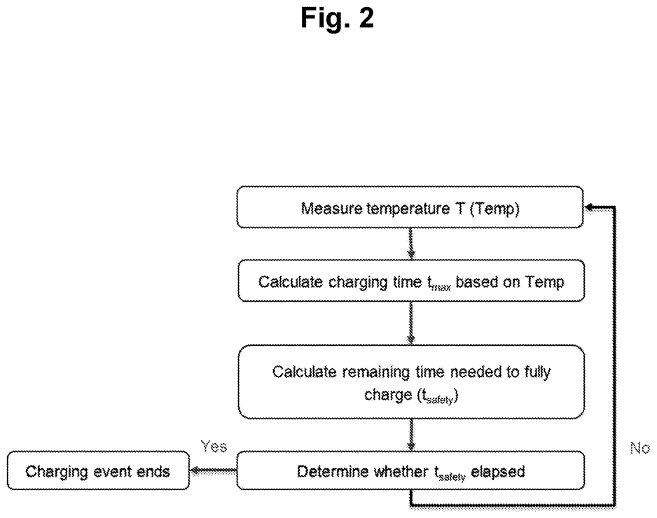

FIG. 2 shows a general flow chart for the method for adjusting the safety timer;

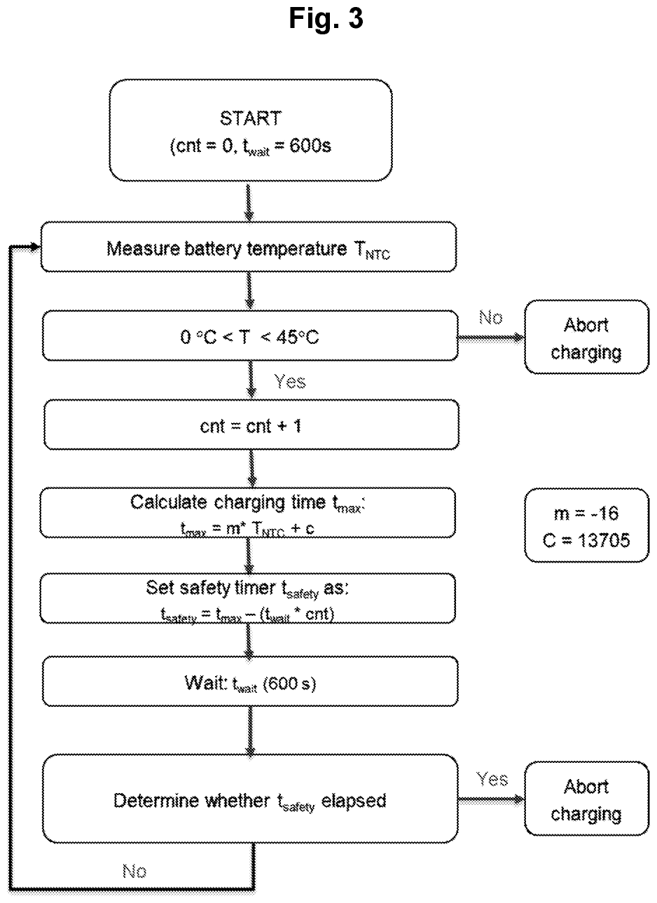

FIG. 3 shows an implementation of the method for adjusting the safety timer;

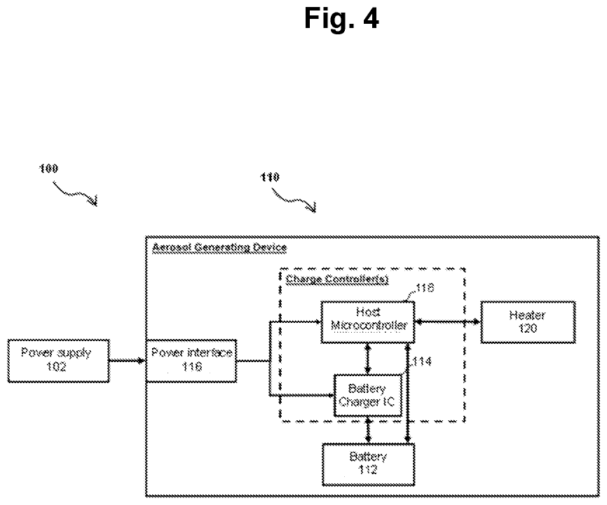

FIG. 4 shows a set-up of an aerosol-generating system;

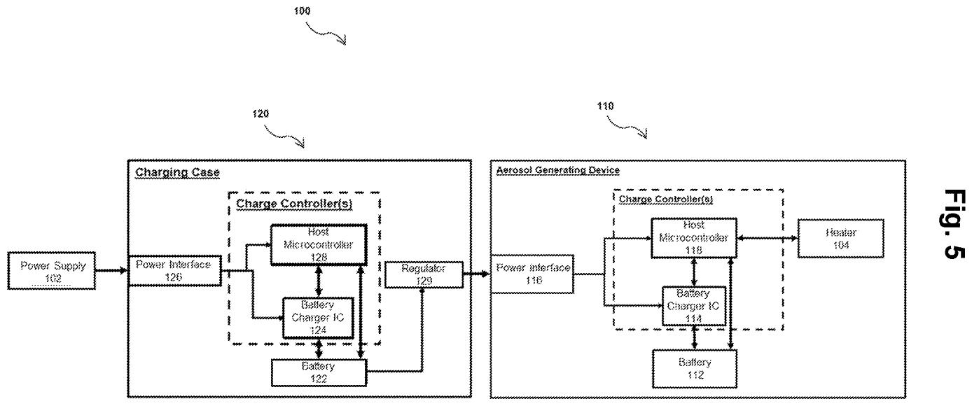

FIG. 5 shows an aerosol-generating system including a charging case; and

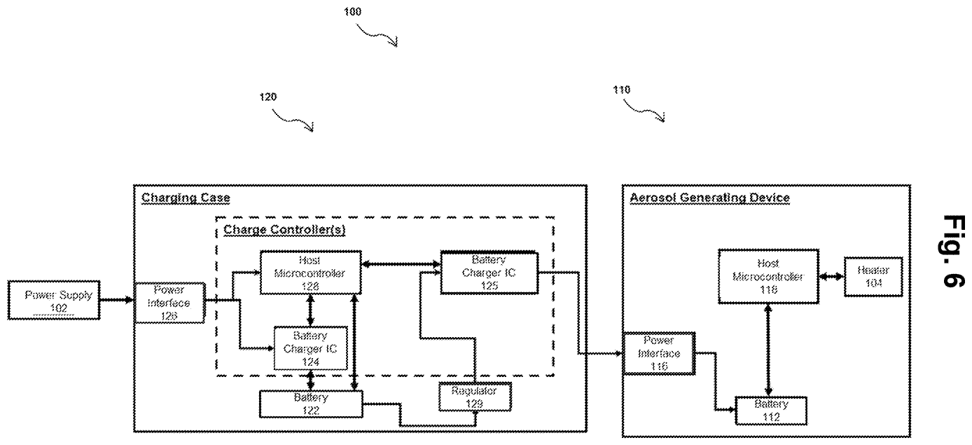

FIG. 6 shows modification of the aerosol-generating system of FIG. 5.

In the diagram of FIG. 1 the required charging time in dependence of the battery temperature is depicted for the temperature range between 0 and 45 degrees Celsius. In the temperature range between 25 and 42 degrees Celsius maximum charging current can be applied for charging the battery. Therefore, in this temperature interval the required charging time is the shortest. In the temperature intervals between 15 and 25 degrees Celsius and between 42 and 45 degrees Celsius a slightly reduced charging current is applied. Accordingly, the required charging time is slightly increased, but is still well below one hour.

At reduced temperatures below 15 degrees Celsius a significantly lower charging current is typically used. For this reason, the required charging time increases in the temperature range between 5 and 15 degrees Celsius. In this temperature range the required charging time doubles to about 1.6 hours. At even lower temperatures in the temperature range between 0 and 5 degrees Celsius, the required charging time increases even more and amounts to about 2.7 hours.

In conventional charging methods a constant safety timer functionality is used. The safety timer is programmed to terminate charging of the battery when the charging time exceeds a specified time limit. In prior art devices, the time limit is set to a fixed value, for example 4 or 5 hours. Such time limit ensures that throughout the full temperature range, in which charging is allowed, a full charge of the battery can be accomplished.

Such fixed safety timers are usually longer than the time needed to fully charge the battery in low temperature conditions. Accordingly, the fixed safety timer is usually much longer than the time needed to fully charge the battery in advantageous temperature conditions of between 15 and 45 degrees Celsius. Accordingly, with such setting, if the battery is not in a normal condition during charging, in other words if there is a faulty battery, termination of charging process, is considerably delayed.

FIG. 2 shows a general flowchart of the charging method implementing a dynamic safety timer functionality. At the beginning of the charging process, the battery temperature is measured either directly or indirectly. Therefore, the battery temperature may be referred to as a temperature indicative of the temperature of the battery. Based on the battery temperature the required maximum charging time is calculated. The safety timer is set according to the calculated maximum charging time. If the safety time has elapsed, charging is terminated. If the safety time has not yet elapsed, charging is continued and the above-described method is repeated.

FIG. 3 shows a possible implementation of the dynamic safety timer charging method. Charging is enabled when the device detects a charging voltage level at a charging adapter. At the beginning of the charging process, a counter cnt is set to a value of −1 and a predefined waiting time t_{waiting} is read out from a controller memory. In the present case the waiting time t_{waiting} is set to 600 seconds.

After that the battery temperature T_{NTC} is measured via NTC thermistor. The charging controller determines, if the battery temperature T_{NTC} is within the operational temperature range. In the scheme depicted in FIG. 3 the operational temperature range is set to range from 0 to 45 degrees Celsius. If the battery temperature is outside of this operational interval, charging is terminated.

If the battery temperature is within the operational interval, charging is continued. The counter cnt is increased by 1. In a next step the maximum charging time tₘₐₓ is calculated using the following equation:

$${t}_{max} ( T ) = m \cdot T + c \qquad ( 1 )$$

Wherein T is the battery temperature and m, c are empirically determined parameters. The parameters used in this exemplary charging method are determined to m=−16 and c=13705. According to this equation, at a temperature T=0 degrees Celsius the maximum charging time tₘₐₓ is calculated to about 3.8 hours. The maximum charging time continuously decreases with rising battery temperature to about 3.6 hours at 45 degrees Celsius. The parameters m and c may be adapted according to specifics of the battery and the aerosol-generating system in which the safety timer functionality is to be implemented.

In a next step the safety timer t_{safety} is set. To this end the following equation is used:

$${t}_{safety} = {t}_{max} ( T ) - ( {t}_{waiting} * cnt ) \qquad ( 2 )$$

Since the cnt is at this moment at a value of “0”, at the start of the charging process the safety timer t_{safety} is set to the maximum charging time tₘₐₓ. After the safety timer is set, charging is continued until expiry of the predetermined period of the waiting time t_{waiting} of 600 seconds.

After the waiting time has elapsed, the controller checks whether the safety timer has elapsed, or in other words, if the safety timer has decreased to or below 0 seconds. If this is the case, charging is aborted.

If the safety timer is still above 0 seconds, the method of FIG. 3 is repeated by measuring the battery temperature. The counter cnt is again increased by 1, and the maximum charging time is re-calculated based on the current battery temperature. The safety timer is re-set according to equation (2) and charging is continued for a further predetermined waiting time t_{waiting}.

The method is repeated and charging is continued until the safety timer has decreased to or below 0 seconds. Once the charging safety timer has decreased to or below 0 seconds, charging is aborted. The charging safety timer may be adapted as deemed suitable. For example, the waiting time may be adapted, the gradient m or the constant c of equation (1) may by varied. Instead of linear equation (1) the maximum charging time may also be calculated from another equation using another linear or non-linear relationship between the battery temperature and the maximum charging time.

Three examples of different architectures for an aerosol generating system 100 implementing the method are shown in FIGS. 4 to 6.

In FIG. 4 the aerosol-generating system 100 comprises an aerosol-generating device 110 that can be connected to an external power supply 102 for charging.

In the depicted example, the power supply 102 is a mains AC adaptor which receives an AC input from the mains, and outputs 5V DC via a USB-C cable. The aerosol-generating 110 device comprises a rechargeable lithium-ion battery 112 and a battery charger IC 114 which controls charging of the battery 112. The battery charger IC 114 receives power from the power interface 116 and delivers it to the battery 112 for charging.

The aerosol-generating device 110 further comprises a host microcontroller 118 for executing the required functions of the aerosol-generating device 110, such as the provision of electrical power to the heater 120 from the battery so that aerosol can be generated from an aerosol-forming substrate.

The battery 112 provides power to the host microcontroller 118 and the heater 120 so that the aerosol-generating device 110 can be used when it is no longer connected to the power supply 102.

In the example of FIG. 5 the aerosol-generating system 100 additionally comprises a charging case 120. Power from the external power supply 102 is used to charge a re-chargeable battery 122 in the charging case 120. In turn, the battery 122 of the charging case 120 is used to charge the battery 112 of the aerosol-generating device 110. The aerosol-generating device 110 has essentially the same construction as in the previous example depicted in FIG. 4.

The charging case 120 comprises a battery 122 and a battery charger IC 124 which controls charging of the battery 122 in the charging case 120. The battery charger IC 124 receives power from the power interface 126 and delivers it to the battery 122 for charging. The power interface 126 for connecting the power supply 102 to the charging case 120 and the power interface 116 for connecting the charging case 120 to the aerosol-generating device 110 are identical and are both USB-C type connections.

The charging case 120 also comprises a host microcontroller 128 for executing the required functions of the charging case 120, such as the downloading of data from the aerosol-generating device 110 and the transmission of this data to an external computer via the USB-C interface.

The charging case 120 includes a regulator 129 which receives power from the charging case battery 122, and outputs a predetermined voltage of 5V to the aerosol-generating device 110. As in the example of FIG. 4, the aerosol-generating device 110 comprises a battery 112 and a battery charger IC 114 which controls charging of the battery 112 in the aerosol-generating device 110. The battery charger IC 114 receives power from its power interface 116 and delivers it to the battery 112 for charging.

In the example of FIG. 6 the aerosol-generating system 100 again comprises a charging case 120 and is similar in most respects to the previous example shown in FIG. 5.

However, in this example, the battery charger IC 125 that charges the battery 112 of the aerosol-generating device 110 is located in the charging case 120 rather than in the aerosol-generating device 110 itself. Thus, all electronic control circuitry related to the charging process is located in the charging case 120. In turn, this means that less circuitry is required to be located in the aerosol-generating device 110. This allows to reduce the number of components of the aerosol-generating device 110 such that a less complex and potentially smaller construction of the aerosol-generating device 110 may be envisaged.

In the exemplary devices described above with reference to FIGS. 4, 5 and 6, the methods described above with reference to FIG. 2 and FIG. 3 may be implemented at the dedicated battery charger IC. In this way, it is possible for the dedicated battery charger IC to operate independently of the host microcontroller such that the maximum charging time can be dynamically adjusted irrespective of whether the host microcontroller is operational. For instance, at very low states of charge of a device's battery, the battery may not be able to provide a sufficient voltage to operate the host microcontroller. Thus, the maximum charging time can be dynamically adjusted even at very low states of charge of the battery.

Alternatively, the methods described above with reference to FIG. 2 and FIG. 3 may be implemented at the host microcontroller. Typically, battery charger ICs have limited programmability whereas host microcontrollers are more adaptable. Therefore, it may be more simple and efficient to implement the methods described above at the host microcontroller.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A method for charging a battery in an aerosol-generating system, the method comprising:
determining a temperature indicative of a temperature of the battery;
calculating a maximum charging time tₘₐₓ depending on the determined temperature; and
terminating charging, if the maximum charging time tₘₐₓ has elapsed,
wherein the maximum charging time tₘₐₓ is adjusted based on a last temperature measurement.

17. A charge controller for an aerosol generating system comprising a battery, the charge controller being configured to:
determine a temperature indicative of a temperature of the battery,
calculate a maximum charging time tₘₐₓ depending on the determined temperature, and
terminate charging, if the maximum charging time tₘₐₓ has elapsed,
wherein the maximum charging time tₘₐₓ is adjusted based on a last temperature measurement.

18. The method according to claim 16,
wherein the temperature indicative of the temperature of the battery is determined via a thermistor or a thermocouple, and/or
wherein the maximum charging time tₘₐₓ is calculated as a linear or non-linear function of the determined temperature.

19. The method according to claim 16, wherein charging of the battery is inhibited if the determined temperature is outside of a predetermined temperature range.

20. The method according to claim 19, wherein the predetermined temperature range is between −10 degrees Celsius to 60 degrees Celsius.

21. The method according to claim 19, wherein the predetermined temperature range may be subdivided into two or more subranges.

22. The method according to claim 21,
wherein the maximum charging time tₘₐₓ is calculated based on a relationship between maximum charging time tₘₐₓ and temperature, and
wherein the relationship is different in each subrange.

23. The method according to claim 16, wherein the temperature indicative of the temperature of the battery is measured periodically during charging.

24. The method according to claim 23, wherein the temperature indicative of the temperature of the battery is measured periodically at a temperature measurement interval.

25. The method according to claim 16, wherein adjustment of the maximum charging time tₘₐₓ is carried out such that only an increase of maximum charging time tₘₐₓ is allowed.

26. The charge controller according to claim 17,
wherein the temperature indicative of the temperature of the battery is determined via a thermistor or a thermocouple, and/or
wherein the maximum charging time tₘₐₓ is calculated as a linear or non-linear function of the determined temperature.

27. The charge controller according to claim 17, wherein charging of the battery is inhibited if the determined temperature is outside of a predetermined temperature range.

28. The charge controller according to claim 27, wherein the predetermined temperature range is between-10 degrees Celsius to 60 degrees Celsius.

29. The charge controller according to claim 27, wherein the predetermined temperature range may be subdivided into two or more subranges.

30. The charge controller according to claim 29,
wherein the maximum charging time tₘₐₓ is calculated based on a relationship between maximum charging time tₘₐₓ and temperature, and
wherein the relationship is different in each subrange.

31. The charge controller according to claim 17, wherein the temperature indicative of the temperature of the battery is measured periodically during charging.

32. An aerosol-generating device comprising a rechargeable battery, a first power interface configured to connect the rechargeable battery to an external power source, and a host controller configured to control power supply from the rechargeable battery to an electric heater,
wherein the host controller comprises the charge controller according to claim 17 configured for charging the rechargeable battery, or
wherein the aerosol-generating device comprises a battery charger IC comprising the charge controller according to claim 17 configured for charging the rechargeable battery.

33. A charging case for an aerosol generating device, comprising a rechargeable battery, a first power interface configured to connect the rechargeable battery of the charging case to an external power supply; and a second power interface configured to connect the rechargeable battery of the charging case to a rechargeable battery of the aerosol-generating device, wherein the charging case further comprises the charge controller according to claim 17 configured for charging the rechargeable battery of the aerosol-generating device.

34. A charging case for an aerosol generating device comprising a rechargeable battery, a first power interface configured to connect the rechargeable battery of the charging case to an external power supply; and a second power interface configured to connect the rechargeable battery of the charging case to a rechargeable battery of the aerosol-generating device,
wherein the charging case further comprises a host microcontroller comprising the charge controller according to claim 17 configured for charging the rechargeable battery of the charging case, or
wherein the charging case further comprises a battery charger IC comprising the charge controller according to claim 17 configured for charging the rechargeable battery of the charging case.

35. A nontransitory computer readable medium having stored thereon a computer program, which when executed by a charge controller, causes the charge controller to perform steps of the method according to claim 16.
